(19) United States
(12) Patent Application Publication
(10) Pub. No.: US 2020/0366883 A1
(43) Pub. Date: Nov. 19, 2020

(54) STEREO CAMERA DEVICE

(71) Applicant: HITACHI AUTOMOTIVE SYSTEMS, LTD., Hitachinaka-shi, Ibaraki (JP)

(72) Inventor: Kazuo MATSUURA, Hitachinaka (JP)

(73) Assignee: HITACHI AUTOMOTIVE SYSTEMS, LTD., Hitachinaka-shi, Ibaraki (JP)

(21) Appl. No.: 16/961,164

(22) PCT Filed: Mar. 1, 2019
(86) PCT No.: PCT/JP2019/008007

§ 371 Date: Jul. 9, 2020

(30) Foreign Application Priority Data
Mar. 8, 2018 (JP) 2018-041402

(51) Int. Cl. H04N 13/296; H04N 13/239; H04N 17/00; G06T 7/593; B60R 11/04

(52) U.S. Cl. CPC H04N 13/296; H04N 13/239; H04N 2013/0081; G06T 7/593; B60R 11/04; H04N 17/002

(57) ABSTRACT

A stereo camera accurately measures the parallax of an object in real time and an accurate distance, even in a device in which the vertical positions of two cameras are mutually offset. A left camera starts to capture an image. An image capturing region of a right camera is set to be below that of the left camera, and the start of image capture by the right camera is delayed. Image capture by the right camera starts after a time difference has elapsed. Feature points in images from the left and right cameras are extracted, and feature points in the vicinity of a height set in advance in the left and right images are extracted. Detection is performed to ascertain whether the average value of a left/right difference for a plurality of points is set in advance, and a difference at the current time is calculated.

### TECHNICAL FIELD

The present invention relates to a stereo camera device.

### BACKGROUND ART

In order to improve running safety of a vehicle, a system has been developed in which a sensor such as a camera is mounted on the vehicle, and distance, direction, and the like of vehicles around the vehicle, pedestrians crossing, bicycles, and the like are measured, and if there is a possibility of collision, a warning to a driver is issued or automatic braking is performed to avoid a collision.

Further, these sensors have been developed as devices not only for avoiding collision but also for grasping surrounding conditions for automatic driving.

There are millimeter-wave radars, laser radars, cameras, and the like as sensors for monitoring the surroundings of vehicles. The sensor using a camera includes a monocular camera and a stereo camera using a plurality of cameras.

The stereo camera can measure the distance to an image-captured object by using the disparity due to the difference in viewpoint positions of images in an overlapping area of the images captured by any two cameras separated by a predetermined distance.

At this time, a vehicle equipped with the camera, a preceding vehicle whose image is captured, a pedestrian, and the like are moving with time, therefore, in order to perform accurate measurement, images of objects such as the vehicle and the pedestrian captured by two cameras need to be captured at the same time.

However, heights of the two cameras may change, such as the relative height of the two cameras being offset from the time of attachment to the vehicle, or the heights of the two cameras changing due to a vehicle attitude. In recent years, most of complementary metal oxide semiconductor (CMOS) sensors used as imaging devices sequentially obtain and transfer image-captured data from top to bottom direction or vice versa for each horizontal line direction in pixel units (rolling shutter system).

Therefore, even when image capture timings of the two cameras are adjusted at the same time, if the attached heights of the two cameras change relative to each other, the same portion of the object image-captured by the two cameras may be different in the image capturing time.

Because the distance is measured by using the disparity of the same portion, when the position of the same portion is temporally offset, the disparity changes, and the correct distance cannot be measured.

In the technique described in Patent Literature 1, a vehicle manufacturer, a camera manufacturer, or the like installs a marker in the field of view in order to detect a positional offset of a camera, and the offset is detected regularly (after turning the ignition of the vehicle ON, weekly, monthly, or the like) or at the time of dealer inspection, and the image capture timing of the CMOS image sensors are adjusted.

Further, in the technique described in Patent Literature 2, a stereo camera is attached at the time of shipping adjustment in a factory, and then a test chart is image-captured to set positional offset of the camera and adjust the image capture timing.

Further, in the technique described in Patent Literature 3, a method of detecting positional offset of a camera is not specified, however, the adjustment is made by changing not the image capture timing but a starting line position by the number of pixels according to an amount of optical axis offset.

### CITATION LIST

### Patent Literature

PTL 1: JP 2012-198075 A

PTL 2: JP 2004-32244 A

PTL 3: JP 2012-227773 A

### SUMMARY OF INVENTION

### Technical Problem

However, as described above, the determination of whether or not the positional offset of the stereo camera has occurred is performed regularly, or at the time of dealer inspection or the like, when the vehicle is actually used, it is desirable to determine in real time whether or not the positional offset of the stereo camera has occurred even while the vehicle is traveling from the viewpoint of improving safety.

Here, in order to expand the vertical angle of view of the stereo camera, the vertical positions of the two cameras may be intentionally offset from each other. This is applied, for example, in order to capture a region where left and right images overlap for normal stereoscopic viewing for the purpose of normal front monitoring, and to capture an image to determine the lamp colors of the traffic light by only one of the cameras.

In this case, the start time of image capture of the left and right cameras needs to be shifted, which causes a difference in scanning time between the two cameras. There is no problem if the relative position between the camera and the preceding vehicle does not change due to this time difference, however, a problem occurs, for example, if the preceding vehicle moves laterally with respect to the two cameras.

That is, when the preceding vehicle moves laterally, in addition to the disparity, an error corresponding to the distance the preceding vehicle has moved occurs, and the correct disparity cannot be measured.

As for the stereo camera in which the vertical positions of the two cameras are mutually offset intentionally, it is desirable to determine in real time whether or not the positional offset of the stereo camera has occurred as described above, from the viewpoint of improving safety.

None of the above Patent Literatures 1, 2, and 3 considers determining in real time whether or not the positional offset of the stereo camera has occurred.

Further, all of the above Patent Literatures 1, 2, and 3 are intended to solve the problem that occurs when the optical axis is offset from the set position, and do not mention about the problem that occurs when the optical axes of the two cameras are intentionally arranged to be mutually offset for the purpose of expanding the angle of view, and do not describe about the real-time determination and correction of the positional offset of the stereo camera in which the vertical positions of the two cameras are mutually offset.

An object of the present invention is to provide a stereo camera device that can accurately measure the disparity of an object in real time and measure an accurate distance even in a device in which the vertical positions of two cameras of the rolling shutter system are mutually offset intentionally.

### Solution to Problem

In order to achieve the above object, the present invention is configured as follows.

In a stereo camera device having a first image capturing unit that obtains a first image and a second image capturing unit that obtains a second image, the first image and the second image have a portion where image capturing regions overlap with each other and a portion where the image capturing regions do not overlap with each other, and the portion where the image capturing regions overlap with each other is image-captured at substantially the same timing by the first image capturing unit and the second image capturing unit.

### Advantageous Effects of Invention

According to the present invention, a stereo camera device is realized, which can accurately measure the disparity of an object in real time and measure the accurate distance even in a device in which the vertical positions of two cameras of the rolling shutter system are mutually offset intentionally.

### BRIEF DESCRIPTION OF DRAWINGS

FIG. 1 is an operation flowchart of a stereo camera device according to an example 1 of the present invention.

FIG. 2 is a schematic functional block diagram of the stereo camera device according to the example 1.

FIG. 3 is an operation explanatory diagram of a feature point extraction unit.

FIG. 4 is an operation flowchart in an example 2.

FIG. 5 is an explanatory diagram of image capture timing of a region where image capturing regions do not overlap.

FIG. 6 shows a principle of distance measurement using a stereo camera.

FIG. 7 is an explanatory diagram showing a state in which image capturing ranges of two cameras are intentionally made uneven in the vertical direction in order to expand the region image-captured by the stereo camera.

FIG. 8 is a diagram illustrating a problem that occurs when a preceding vehicle moves laterally in a rolling shutter system.

### DESCRIPTION OF EMBODIMENTS

Prior to descriptions of examples of the present invention, a principle of the present invention is described.

FIG. 6 shows the principle of distance measurement using a stereo camera.

In FIG. 6, a stereo camera 61 is arranged in a host vehicle, and cameras 62 and 63 are arranged on the left and right sides respectively, separated by a base line length B. When a preceding vehicle 64 is image-captured while the stereo camera 61 is arranged in this way, an image 65 captured by the right camera (first image capturing unit) 62 and an image 66 captured by the left camera (second image capturing unit) 63 are obtained.

The preceding vehicle 64 shown in the image 65 and the preceding vehicle 64 shown in the image 66 are different from each other in terms of viewpoint positions of the left and right cameras 62 and 63 that an offset occurs disparity d according to a distance Z between the left camera 63 and the preceding vehicle 64.

The distance Z and the disparity d have a relationship as in the following formula (1) when lenses having the same focal length f are used in the left and right cameras.

Z=f×B/d (1)

When the disparity d is measured using the above formula (1), the distance Z can be detected.

At this time, the left and right images 65 and 66 need to be captured at the same time.

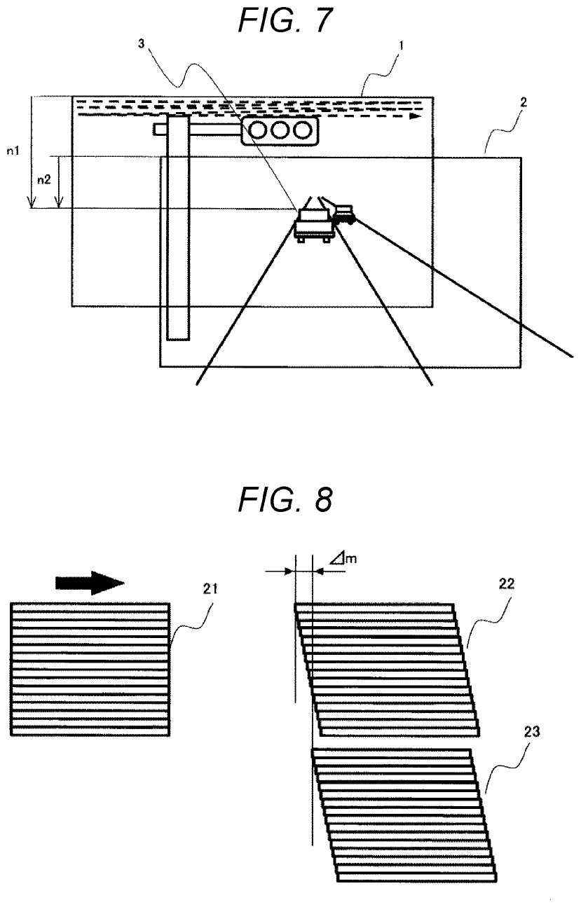

Next, reference is made to FIG. 7. FIG. 7 is an explanatory diagram showing a state in which image capturing ranges of the two cameras are intentionally made uneven in the vertical direction in order to expand the region image-captured by the stereo camera.

In FIG. 7, a case is described in which the images of a preceding vehicle 3 being the vehicle to be detected in the images captured by the left and right cameras, cannot be obtained at the same time. As a shutter system of an imaging device, there are a global shutter system in which all pixels of the entire screen are exposed at the same time, and a rolling shutter system in which each pixel line in the horizontal direction is exposed and sequentially read from top to bottom.

Most CMOS sensors, which are general-purpose imaging devices, use the rolling shutter system. Therefore, an example of the rolling shutter system is described.

Here, as shown in FIG. 7, an image capturing range 1 of the left camera and an image capturing range 2 of the right camera do not match in the vertical direction. The left and right image ranges do not match in the vertical direction mainly because of the following two reasons.

One reason is that originally, the cameras are designed so as to make the image capturing ranges match each other, however, offset may occur when the cameras are installed in offset positions within tolerance during assembly, when the stereo camera is attached in an offset manner during installation on the vehicle or the like, or due to factors such as aging.

The other reason is that the image capturing ranges are intentionally offset in order to expand a vertical angle of view of the stereo camera. This is applied, for example, in order to capture a region where left and right images overlap for normal stereoscopic viewing for the purpose of normal front monitoring, and to capture an image to determine the lamp colors of the traffic light by only one of the cameras.

At this time, it is assumed that the left and right cameras start image capture processing with a time difference provided between the left and right cameras (the left camera starts image capturing first). To a line at an upper end position of the preceding vehicle 3, the time from the start until reaching the line at n1 elapses in an image 1 of the left camera, and the time from the start until reaching the line at n2 elapses in an image 2 of the right camera.

Therefore, there is a scanning time difference (n1−n2) in the image of the upper end of the same vehicle 3 between the image 1 of the left camera and the image 2 of the right camera. A problem does not occur if relative positions of the left and right cameras and the preceding vehicle 3 do not change during this time difference (n1−n2). However, for example, if the preceding vehicle moves laterally with respect to the left and right cameras, the problem occurs.

FIG. 8 is a diagram illustrating the problem that occurs when a preceding vehicle moves laterally in the rolling shutter system. In FIG. 8, a vehicle shape is represented as a quadrangle shape 21 in order to simply represent the shape of the preceding vehicle or the like. Now, assuming that the preceding vehicle is moving to the right in FIG. 8, in the case of the rolling shutter system, because the exposure and reading is sequentially performed from the top line, the shape becomes a parallelogram 22. Further, as shown in FIG. 7, if image capturing areas of the left and right cameras are vertically offset from each other, or are vertically offset intentionally, the image captured by the left camera becomes the parallelogram 22, and the image captured by the right camera also becomes a parallelogram 23. However, in addition to the disparity, the offset by an error Δm occurs for a distance that the preceding vehicle has moved laterally for the time (n1−n2), and the problem occurs that the disparity cannot be correctly measured.

If the disparity is not correctly measured, the disparity d in the above formula (1) cannot be obtained, therefore, the distance between the preceding vehicle and the camera cannot be accurately calculated.

Accordingly, the present invention is configured such that, when a position setting of the left and right cameras is offset from a predetermined distance due to aging or the like, the image capture timings of the left and right cameras are corrected in real time to enable accurate measurement of the distance to the preceding vehicle.

The real-time correction of the image capture timing of the left and right cameras can be realized even with a stereo camera device in which the left and right cameras are vertically offset intentionally.

Embodiments of the present invention are described below with reference to the drawings and the like. Examples described below is the examples in which the present invention is applied to a stereo camera device in which the left and right cameras are vertically offset intentionally.

### EXAMPLES

### Example 1

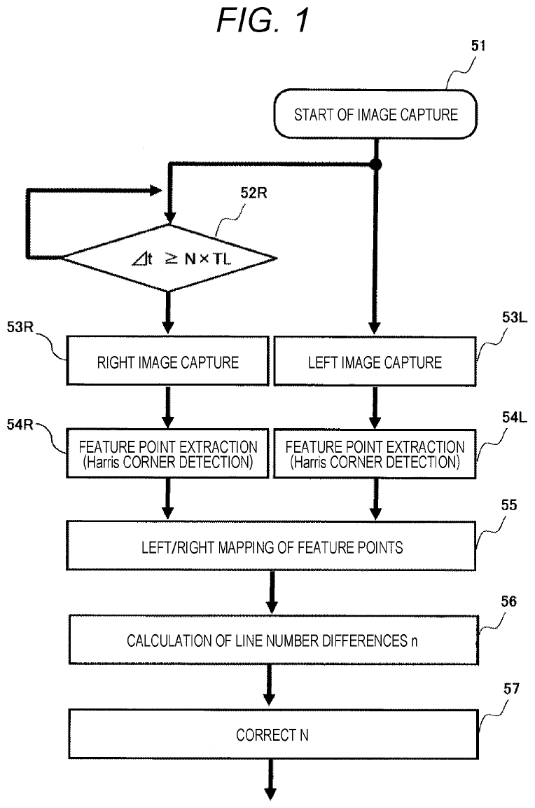

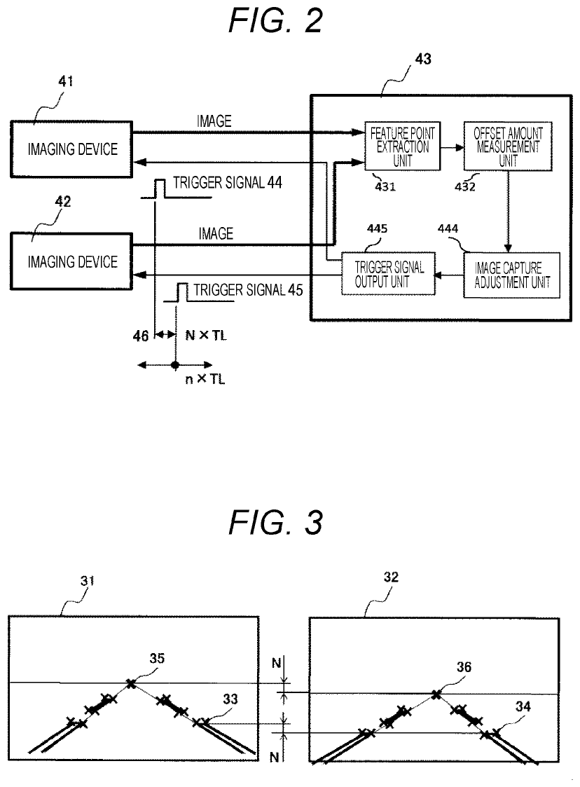

FIG. 1 is an operation flowchart of a stereo camera device according to an example 1 of the present invention, and FIG. 2 is a schematic functional block diagram of the stereo camera device according to the example 1.

In FIG. 2, the stereo camera device 61 (shown in FIG. 6) arranged in the host vehicle in the example 1 includes an imaging device 41 of the left camera (second image capturing unit) 63, an imaging device 42 of the right camera (first image capturing unit) 62, and a microcomputer 43 that controls the operation of the imaging device 41 and the imaging device 42. The microcomputer 43 includes a feature point extraction unit 431, an offset amount measurement unit 432, an image capture adjustment unit 444, and a trigger signal output unit 445.

In the stereo camera device 61 of the example 1, the left camera 63 and the right camera 62 are set in advance with a difference of N lines of image-capturing and scanning lines. That is, the left camera 63 located on the left side has an image capturing region set upward by N lines from the right camera 62 located on the right side of the left camera 63.

In FIG. 1, the left and right cameras 62 and 63 start image capture at the start of image capture (step 51). However, the left camera 63 starts image capture from the image capture start step 51 (step 53L).

On the other hand, because the image capturing region of the right camera 62 is set below that of the left camera 63, the start of image capture by the right camera is delayed by the time Δt in step 52R, until Δt≥N×TL is satisfied, with respect to the number N of vertical offset lines between the left and right cameras 62 and 63×line operation time TL. Note that TL is the line scanning time.

In FIG. 2, the trigger signal output unit 445 of the microcomputer 43 outputs a trigger signal 44 to the imaging device 41 of the left camera 63 to start image capture, and the trigger signal output unit 445 outputs a trigger signal 45 to the imaging device 42 of the right camera 62 to start image capture.

There is a time difference 46 (N×TL) between the trigger signals 44 and 45. However, it is assumed that the time n×TL has elapsed from the image capture start time. A value of n is arbitrary.

After the imaging device 41 of the left camera 63 starts image capture, the time difference 46 elapses and the imaging device 42 of the right camera 62 starts image capture (step 53R).

Next, in steps 54R and 54L, the feature point extraction unit 431 extracts feature points in the left image (second image) 31 of the left camera 63 and the right image (first image) 32 of the right camera 62.

FIG. 3 is an operation explanatory diagram of the feature point extraction unit 431. In FIG. 3, Harris corner detection is performed as feature point extraction on each of the left image 31 and the right image 32. Here, corners that appear in a lane mark (for example, an end of a broken line when the lane mark is the broken line (broken line end)), are extracted as x marks 33 and 34 (image feature points (corner extraction points)) shown in FIG. 3.

Previously, the x marks 33 and 34 are extracted in the vicinity of left and right height positions set in the left image 31 and the right image 32 (steps 54R and 54L), and it is detected whether or not an average value of left and right differences of the extracted plural points is equal to or more than a preset N (step 55).

As another detection method, it is also possible to adopt a method of detecting whether a vertical difference between points 35 and 36 (left and right lane mark intersection), each of which is obtained by calculating a position where the left and right lane marks intersect, is larger or smaller than the preset N.

Next, the offset amount calculation unit 432 measures a difference n (offset amount) between the number of lines detected in step 56 of FIG. 1, at the actual current point in time. Next, using the calculated difference n, in step 57, the image capture adjustment unit 444 corrects the position difference N which is set so far. Based on this corrected position difference N, the image capture adjustment unit 444 perform control to command the trigger output unit 445 to output the trigger signal for starting image capture, and the image capture timings or the image capture positions of the right camera 62 and the left camera 63 are adjusted (image capture timings of the imaging devices 41 and 42 of the cameras 62 and 63 are adjusted).

Thereafter, the position difference N is used to execute steps 51, 53R, 53L, 54R, 54L, 55 to 57, and the position difference N is updated in real time.

As described above, according to the example 1 of the present invention, the respective images captured by the imaging devices 41 and 42 of the left and right cameras 62 and 63 while the vehicle is actually traveling are compared with each other, the feature points are extracted to determine whether or not the offset amount is the preset offset amount, and if the offset amount is not the preset offset amount, the image capture timings of the imaging devices 41 and 42 of the cameras 62 and 63 are adjusted so as to make the offset amount become the set offset amount.

Therefore, even in a stereo camera device in which the vertical positions of the two cameras of the rolling shutter system are mutually offset intentionally, it is possible to realize the stereo camera device that can accurately measure the disparity with respect to a target object in real time and measure the accurate distance.

It should be noted that the above-described operation of correcting the offset amount can be performed for each image capturing frame, and can be performed in real time even during the adjustment work by the car manufacturer and when an engine is turned on.

### Example 2

Next, an example 2 of the present invention is described.

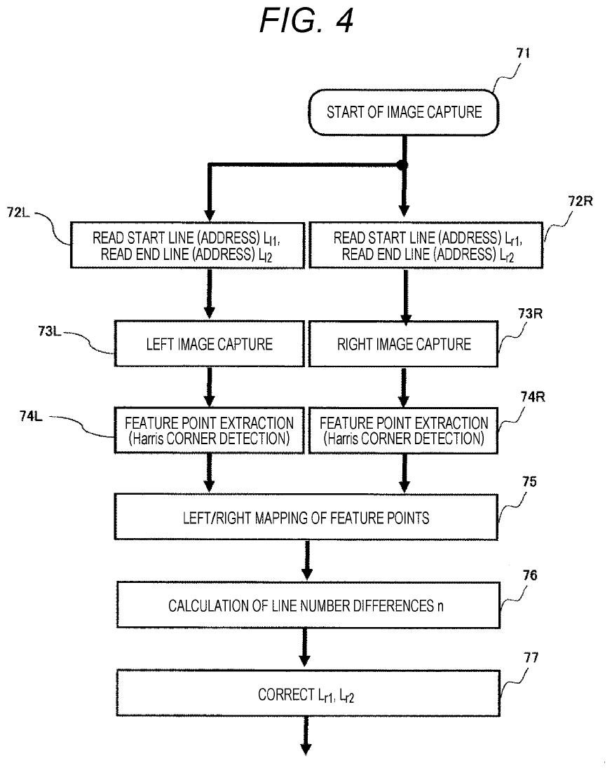

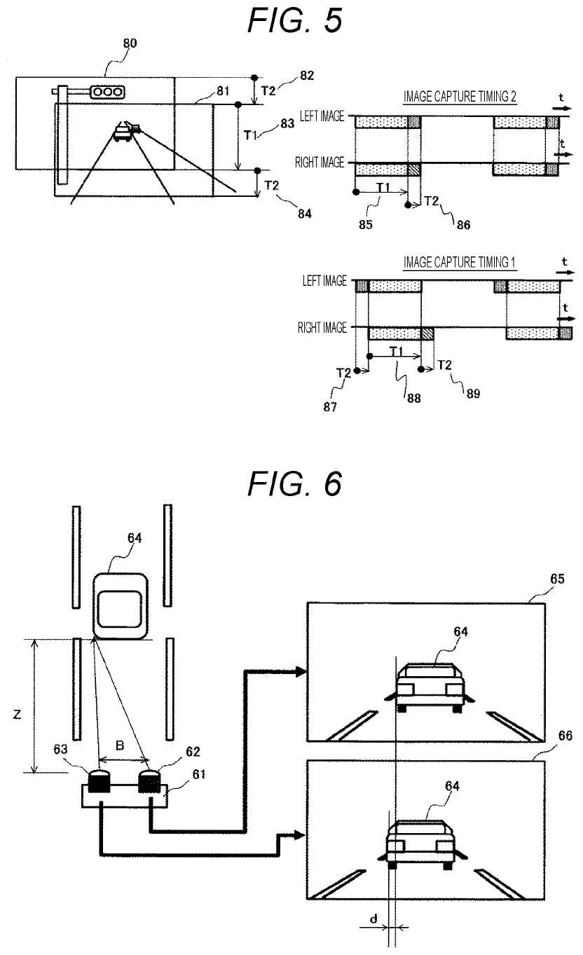

FIG. 4 is an operation flowchart in the example 2, and FIG. 5 is a diagram for explaining the example 2 in comparison with the example 1.

A device configuration in the example 2 is similar to that of the block diagram shown in FIG. 2.

In FIG. 4, image capture starts (step 71), and the image capture adjustment unit 444 transmits a read start line L₁₁ and a read end line L₁₂ to the imaging device 41 of the left camera 63, and transmits a read start line Lᵣ₁ and a read end line Lᵣ₂ to the imaging device 42 of the right camera 62 (steps 72L and 72R).

Then, in steps 73L and 73R, images are captured from the image capture start line to the image capture end line of the imaging devices 41 and 42 of the left and right cameras 63 and 62, respectively.

Steps 74L, 74R, 75 and 76 are the same as steps 54L, 54R, 55 and 56 of FIG. 1 of the example 1.

In step 77, the image capture timing of the right camera 62 is corrected by the detected offset amount (difference in the number of lines).

So far, the description has been made in which the image capturing regions of the left and right cameras 63 and 62 overlap. However, the description is made with reference to FIG. 5 on the image capture timing of regions where the image capturing regions do not overlap.

In FIG. 5, the image capturing time of the right camera 62 is divided into an image capturing time T2 (82) in a monocular region of an image capturing region 80 and an image capturing time T1 (83) including stereo vision, and the image capturing time of the left camera 63 is divided into the image capturing time T2 (84) in the monocular region of an image capturing region 81 and the image capturing time T1 (83) including stereo vision.

However, as described in FIG. 4, during the image capturing time T1 (83) in the stereo vision, the left and right cameras 62 and 63 capture images at the same time. After that, the monocular regions of the left and right cameras 62 and 63 are captured at the timing of the image capturing time T2 (84) (image capture timing 2 of FIG. 5 (example 2)).

As shown in an image capture timing 1 of FIG. 5 (in the case of the example 1), the monocular region of the left camera 63 is captured at the timing T2 (87), and the stereo images from the left and right cameras 62 and 63 are captured at the timing T1 (88), and the monocular region of the right camera 62 can be captured at the timing T2 (89). That is, the first image capturing unit and the second image capturing unit capture images at different timings for portions where the image capturing regions of the first image and the second image do not overlap with each other.

However, in order to shorten a frame interval and shorten an image capturing period, it is better to set the image capture timing 2 (example 2) in which the capture timings of the monocular regions of the left and right cameras 62 and 63 are the same time. That is, in the portion where the image capturing regions of the first image and the second image do not overlap with each other, the first image capturing unit and the second image capturing unit capture images at substantially the same timing.

According to the example 2 of the present invention, it is possible to obtain the same effect as that of the example 1, and further, it is possible to shorten the frame interval and shorten the image capturing period.

As described above, according to the present invention, even when the heights of two arbitrary camera positions are changed in the camera with the rolling shutter system which is often adopted as an imaging device, the stereo camera device can be realized in which the disparity for the target object can be accurately measured in real time, the accurate distance can be measured, collision with a vehicle, a pedestrian, or the like can be avoided, or the accurate data can be provided to the automatic driving system.

The stereo camera device according to the present invention is particularly effective when used in an environment where the usage environment (temperature, humidity, and the like) easily changes.

In addition, the stereo camera device according to the present invention is applicable not only to the vehicle, but also to a device such as a moving body including a mobile robot used in a factory or the like, for measuring a distance to a target object located in front or rear and controlling speed, moving direction, and the like. Note that in the above-described examples 1 and 2, the description is made of the examples in which the positions of the left and right cameras 62 and 63 are mutually offset in the vertical direction. This is because line readout of imaging devices 41 and 42 is in the horizontal direction and an influence may occur on the disparity calculation. However, if the imaging elements 41 and 42 are arranged after being rotated by 90 degrees, the two cameras are not mutually offset in the vertical direction but in the horizontal direction to determine the timing.

Further, in the above-described examples, the Harris corner detection method is used as the feature point extraction, however, it is also possible to use other corner detection methods (Moravec detection method or the like).

Further, the above-described examples are examples in which the present invention is applied to the stereo camera device in which the left and right cameras are intentionally offset in the vertical direction, however, it is also applicable to a stereo camera device in which the left and right cameras are arranged in the same position in the vertical direction.

Further, in the above-described examples, the image capture adjustment unit 444 and the trigger signal output unit 445 are provided separately, however, it is also possible to configure the image capture adjustment unit 444 to output the trigger signal, and to omit the trigger signal output unit 445.

### REFERENCE SIGNS LIST

1, 31, 66, 80 right camera image capturing region
2, 32, 65, 81 left camera image capturing region
3, 64 preceding vehicle
33, 34 image feature point (corner extraction point)
35, 36 left and right lane mark intersection
41, 42 imaging device
43 microcomputer
44, 45 trigger signal
62 right camera
63 left camera
431 feature point extraction unit
432 offset amount measurement unit
444 image capture adjustment unit
445 trigger signal output unit

1. A stereo camera device comprising:
a first image capturing unit that obtains a first image; and
a second image capturing unit that obtains a second image,
wherein the first image and the second image have a portion where image capturing regions overlap with each other and a portion where the image capturing regions do not overlap with each other, and the portion where the image capturing regions overlap with each other is image-captured at substantially equal timings by the first image capturing unit and the second image capturing unit.

2. The stereo camera device according to claim 1, comprising:
a feature point extraction unit that extracts feature points from the first image and the second image, respectively;
an offset amount measurement unit that measures an offset amount between the feature points of the first image and the feature points of the second image extracted by the feature point extraction unit; and
an image capture adjustment unit that adjusts image capture timing or an image capture start position of the first image capturing unit and the second image capturing unit according to the offset amount measured by the offset amount measurement unit.

3. The stereo camera device according to claim 2, wherein each of the first image capturing unit and the second image capturing unit has an imaging device,
the stereo camera device further comprising a trigger signal output unit that outputs, in response to a command from the image capture adjustment unit, a trigger signal to start image capture to the imaging device of the first image capturing unit and the imaging device of the second image capturing unit.

4. The stereo camera device according to claim 2, wherein the first image capturing unit and the second image capturing unit capture images at different timings in the portion where the image capturing regions of the first image and the second image do not overlap with each other.

5. The stereo camera device according to claim 2, wherein the first image capturing unit and the second image capturing unit capture images at substantially equal timings in the portion where the image capturing regions of the first image and the second image do not overlap with each other.

6. The stereo camera device according to claim 4, wherein the stereo camera device is arranged on a moving body, and controls speed and moving direction of the moving body by measuring a distance to a target object located in front of the moving body.

7. The stereo camera device according to claim 6, wherein the moving body is a vehicle.

8. The stereo camera device according to claim 2, wherein the first image capturing unit and the second image capturing unit have imaging devices of a rolling shutter system.
